(19) United States
(12) Patent Application Publication
(10) Pub. No.: US 2012/0301604 A1
(43) Pub. Date: Nov. 29, 2012

(54) USE OF ELECTRO-STATIC MASK TO APPLY LAYERS TO AN ELECTRO-ACTIVE OPTICAL ELEMENT

(75) Inventors: Robert S. Hall, Roanoke, VA (US); Anita Trajkovska, Christiansburg, VA (US)

(73) Assignee: PixelOptics, Inc. (027497), Roanoke, VA (US)

(21) Appl. No.: 13/481,117

(22) Filed: May 25, 2012

Related U.S. Application Data
(60) Provisional application No. 61/489,909, filed on May 25, 2011.

(51) Int. Cl. B05D 1/32

(52) U.S. Cl. 427/58

(57) ABSTRACT

A method for manufacturing an electro-active lens may be provided. The method may comprise the steps of providing a substrate having a first surface; disposing a mask over at least a portion of the first surface of the substrate, where the mask comprises an electro-static plastic material and where the mask has at least one opening; and depositing a layer of material through the at least one opening of the mask.

### CROSS-REFERENCES TO RELATED APPLICATIONS

This application claims benefit under 35 U.S.C. §119(e) of U.S. provisional patent application No. 61/489,909, filed on May 25, 2011, the entire disclosure of which is incorporated herein by reference for all purposes.

### BACKGROUND OF THE INVENTION

Electronic (i.e. “electro-active”) lenses that are configured to have their optical properties altered by way of passing an electrical current or potential across a layer of material (such as a liquid crystal layer) disposed between two electrodes are generally known. In the case of a pixilated electronic lens the electrodes may be individually addressable and thus multiple electrodes may be required, but in the case of a surface relief diffractive optic, only two electrodes are generally needed: one disposed on the top substrate and one disposed on the bottom substrate. One or more of the layers of the electro-active lens may be deposited through a mask, which is typically coupled to one of the substrates of the lens using an adhesive material.

### BRIEF SUMMARY OF THE INVENTION

Embodiments provided herein may comprise methods of manufacturing an electro-active lens that may comprise the use of a mask to deposit one or more layers of material over a surface of a substrate, such as one or more conductive layers, alignment layers, or any other patterned layer of material. The mask may comprise properties such that it may be coupled to a surface of the substrate based, at least in part, on electro-static forces. In some embodiments, this may reduce or eliminate the use of adhesive materials or similar materials that are typically used to hold the mask in place, which can contaminate one or more of the electro-active layers of the device, require additional processing steps to remove such layers, and/or otherwise affect the appearance or performance of the electro-active lens.

In some embodiments, a method for manufacturing an electro-active lens may be provided. The method may comprise the steps of providing a substrate having a first surface; disposing a mask over at least a portion of the first surface of the substrate, where the mask comprises an electro-static plastic material and where the mask has at least one opening; and depositing a layer of material through the at least one opening of the mask.

In some embodiments, in the method as described above, the electro-static plastic material may comprise a vinyl film. In some embodiments, the vinyl film may comprise PVC.

In some embodiments, in the method as described above, the mask may have a thickness that is between 50 and 200 microns. In some embodiments, the mask may have a thickness that is less than 200 microns. In some embodiments, the mask may have a thickness that is greater than 50 microns.

In some embodiments, in the first method as described above, the mask may adhere to the first surface of the substrate based on an electro-static interaction. In some embodiments, the electro-static interaction may create an electro-static force between the first surface of the substrate and the mask of at least 200N. In some embodiments, the electro-static interaction may create an electro-static force between the first surface of the substrate and the mask of at least 600N. In some embodiments, the electro-static interaction may create an electro-static force between the first surface of the substrate and the mask of between 200 and 600N. In some embodiments, the electro-static interaction may create a peel strength of at least 0.1 N per 25 mm width.

In some embodiments, in the method as described above, the mask may be flexible.

In some embodiments, the mask may comprise a material having a flexural rigidity between 30 and 60 MPa.

In some embodiments, the method as described above may further include the steps of disposing a liner between the mask and the substrate. In some embodiments, the liner that is disposed between the mask and the substrate may comprise any one of, or some combination of polyolefins (e.g. PP, HDPE, LDPE), PVC, PET, or paper.

In some embodiments, in the method as described above, the step of depositing the layer of material through the at least one opening of the mask may comprise spin coating, spray, dip-coating, or any other suitable process.

In some embodiments, in the method as described above, the step of disposing the mask over at least a portion of the first surface of the substrate may comprise aligning the mask based at least in part on an optical feature disposed on the first surface of the substrate. In some embodiments, the step of aligning the mask based at least in part on an optical feature disposed on the first surface of the substrate comprises aligning the mask such that at least one opening of the mask is disposed over the optical feature. In some embodiments, the optical feature may comprise a diffractive element.

In some embodiments, in the method as described above, an adhesive layer may not be disposed between the substrate and the mask.

In some embodiments, in the method as described above, the layer of material deposited through the at least one opening of the mask may comprise any one of, or some combination of: a conductive layer or a liquid crystal alignment layer. In some embodiments, where the layer of material deposited through the at least one opening of the mask comprises a conductive layer, the layer may comprise a transparent conductive oxide (TCO) such as ITO or IZO. In some embodiments, where the layer of material deposited through the at least one opening of the mask may comprise a liquid crystal alignment layer, the layer may comprise a polyimide, polyvinyl alcohol, polyacrylate, polymethacrylate, polyurethane or epoxy material. In some embodiments, the layer of material deposited through the at least one opening of the mask may comprise a liquid crystal material or electro-chromic material.

In some embodiments, the method as described above may further comprise the step of providing the mask, wherein providing the make comprises die-cutting.

In some embodiments, a method may be provided. The method may comprise providing a substrate having a first surface; disposing a mask over at least a portion of the first surface of the substrate, wherein the mask comprises an electro-static material that creates an electro-static force between the first surface of the substrate and the mask of at least 200N and where the mask has at least one opening; and depositing a layer of material through the at least one opening of the mask.

In some embodiments, in the method as described, the substrate may comprise an outer perimeter and the step of disposing the mask over at least a portion of the first surface of the substrate may comprise positioning at least the one opening over a region of the first surface that extends to within 3.0 mm of the outer perimeter. In some embodiments, the step of disposing the mask over at least a portion of the first surface of the substrate comprises positioning at least the one opening over a region of the first surface that extends to within 1.0 mm of the outer perimeter. In some embodiments, the step of disposing the mask over at least a portion of the first surface of the substrate may comprise positioning at least the one opening over a region of the first surface that extends to the outer perimeter. In some embodiments, the layer of material deposited through the at least one opening of the mask may comprise a conductive material. In some embodiments, the method may further include the step of edging the substrate so as to expose the conductive layer.

In some embodiments, in the method as described, the substrate may comprise an outer perimeter and the first surface of the substrate may comprise an optical feature. In some embodiments, the step of disposing the mask over at least a portion of the first surface of the substrate may comprise positioning at least the one opening over a region of the first surface that extends from the optical feature to the outer perimeter. In some embodiments, the step of disposing a mask over at least a portion of the first surface of the substrate may comprise positioning an opening of the mask over the optical feature.

### BRIEF DESCRIPTION OF THE DRAWINGS

FIG. 1 shows an example of a deposition mask disposed over a portion of a substrate in accordance with some embodiments.

FIG. 2 shows an example of a deposition mask that is disposed over a portion of a substrate that is experiencing “lift,” which may cause defects in the deposition or manufacturing process.

FIG. 3 shows examples of some of the defects that may result when using traditional masks to deposit one or more layers of material on the surface of a substrate. FIG. 3(a) shows a top-view of a deposition mask disposed over a substrate, where the mask is experiencing lift.

FIG. 3(b) shows a cross-sectional view of a portion of the deposition mask and substrate shown in FIG. 3(a).

FIG. 4 shows an opening of an exemplary deposition mask disposed over a substrate in accordance with some embodiments.

FIG. 5 shows an example of a deposition mask having an opening disposed over an optical feature on the surface of a substrate in accordance with some embodiments.

### DETAILED DESCRIPTION OF THE INVENTION

Some terms that are used herein are described in further detail as follows:

As used herein, the term “alignment layer” may refer to a layer of material that controls the alignment of liquid crystals in the absence of an external field and often adheres to the surface of a substrate (such as an electrode, a lens, lens blank, lens wafer, etc.).

As used herein, the term “comprising” is not intended to be limiting, but may be a transitional term synonymous with “including,” “containing,” or “characterized by.” The term “comprising” may thereby be inclusive or open-ended and does not exclude additional, unrecited elements or method steps when used in a claim or to describe an embodiment. For instance, in describing a method, “comprising” indicates that the claim is open-ended and allows for additional steps. In describing a device, “comprising” may mean that a named element(s) may be essential for an embodiment, but other elements may be added and still form a construct within the scope of a claim. In contrast, the transitional phrase “consisting of” excludes any element, step, or ingredient not specified in a claim. This is consistent with the use of the term throughout the specification.

As used herein, a “conductive path” refers to a continuous path for which electrons (i.e. current) may flow from one point to another. The conductive path may comprise one component, or more than one component. For instance, a conductive path may comprise one or more conductive layers, such as electrical leads that may be coupled to an electro-active element of a lens and a conductor or electrical contact disposed in the frames of eyewear.

As used herein, “coupled” may refer to any manner of connecting two components together in any suitable manner, such as by way of example only: attaching (e.g. attached to a surface), disposing on, disposing within, disposing substantially within, embedding within, embedded substantially within, etc . . . “Coupled” may further comprise fixedly attaching two components (such as by using a screw or embedding a first component into a second component during a manufacturing process), but does not so require. Two components may be coupled temporarily simply by being in physical contact with one another. Two components are “electrically coupled” or “electrically connected” if current can flow from one component to another. That is, the two components do not have to be in direct contact such that current flows from the one component directly to the other component. There may be any number of other conductive materials and components disposed electrically between two components “electrically coupled” so long as current can flow there between.

As used herein, a “diffractive element” may refer to a diffractive pattern that may be disposed on the surface of a substrate such as, by way of example only, etching, grinding or molding the surface. Such an optic may comprise a physical structure that is patterned to have a fixed optical power and/or aberration correction, by way of a surface relief diffractive topological profile.

As used herein, the term “layer” does not require a uniform thickness of material. For example, a layer may comprise some imperfections or uneven thicknesses so long as the layer performs its intended purpose.

As used herein, a “lens” may refer to any device or portion of a device that causes light to converge or diverge. The device may be static or dynamic. A lens may be refractive or diffractive. A lens may be concave, convex or plano on one or both surfaces. A lens may be spherical, cylindrical, prismatic or a combination thereof. A lens may be made of optical glass, plastic, or resin. A lens may also be referred to as an optical element, an optical zone, an optical region, an optical power region, or an optic. It should be noted that within the optical industry a lens can be referred to as a lens even if it has zero optical power. Moreover, a lens may refer to both intra-ocular and extra-ocular components.

As used herein, a “lens blank” may refer to an optical material that may be shaped into a lens. A lens blank may be finished meaning that the lens blank has been shaped to have an optical power on both external surfaces. A lens blank may be semi-finished meaning that the lens blank has been shaped to have an optical power on only one external surface. A lens blank may be unfinished meaning that the lens blank has not been shaped to have an optical power on either external surface. A surface of an unfinished or semi-finished lens blank may be finished by means of a fabrication process known as free-forming or by more traditional surfacing and polishing.

As used herein, an “ophthalmic lens” may refer to a lens suitable far vision correction which includes a spectacle lens, a contact lens, an intra-ocular lens, a corneal in-lay, and a corneal on-lay.

As used herein, “optical communication” may refer to the condition whereby two or more optics of given optical power are aligned in a manner such that light passing through the aligned optics experiences a combined optical power equal to the sum of the optical powers of the individual elements.

As used herein, “pixilated electrodes” may refer to electrodes that may be utilized in an electro-active lens that are individually addressable regardless of the size, shape, and arrangement of the electrodes. Furthermore, because the electrodes are individually addressable, any arbitrary pattern of voltages may be applied to the electrodes. For example, pixilated electrodes may be squares or rectangles arranged in a Cartesian array or hexagons arranged in a hexagonal array. Pixilated electrodes need not be regular shapes that fit to a grid. For instance, pixilated electrodes maybe concentric rings if every ring is individually addressable. Concentric pixilated electrodes may be individually addressed to create a diffractive optical effect.

As used herein, a “progressive addition region” or “progressive addition zone” may refer to a lens having a first optical power in a first portion of the region and a second optical power in a second portion of the region wherein a continuous change in optical power exists there between. For example, a region of a lens may have a far viewing distance optical power at one end of the region. The optical power may continuously increase in plus power across the region, to an intermediate viewing distance optical power and then to a near viewing distance optical power at the opposite end of the region. After the optical power has reached a near-viewing distance optical power, the optical power, may decrease in such a way that the optical power of this progressive addition region transitions back into the far viewing distance optical power. A progressive addition region may be on a surface of a lens or embedded within a lens.

When a progressive addition region is on the surface and comprises a surface topography it may be known as a progressive addition surface.

As used herein, a “static lens” or ‘static optic” may refer to a lens having an optical power which is not alterable with the application of electrical energy, mechanical energy or force. Examples of static lenses include spherical lenses, cylindrical lenses, Progressive

Addition Lenses, bifocals, and trifocals. A static lens may also be referred to as a fixed lens. A lens may comprise a portion that is static, which may be referred to as a static power zone, segment, or region.

### DESCRIPTION OF EMBODIMENTS

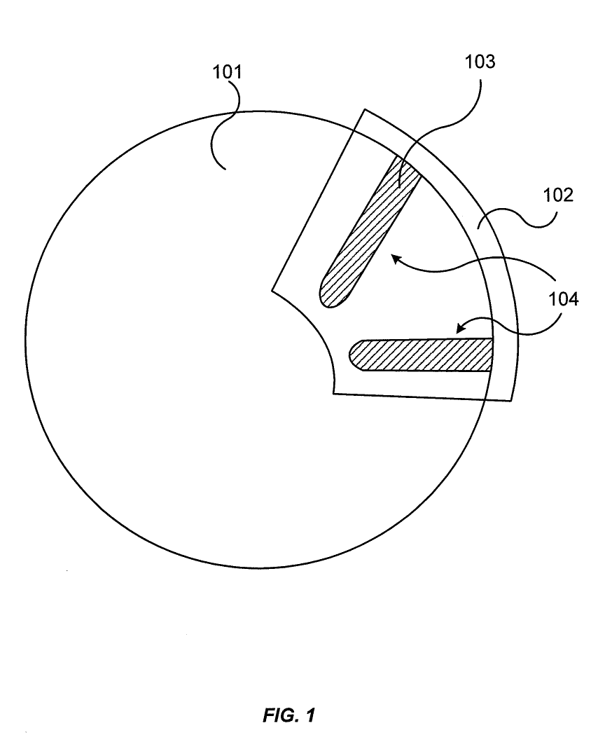

During the manufacturing process of an electro-active lens, some of the layers that may comprise components of the lens may be deposited through a mask. The mask may comprise one or more openings for materials to be deposited through such that they may form a patterned layer of material over portions one or both of the substrates. FIG. 1 shows an example of a mask 102 disposed over a substrate 101, which may comprise a part of an electro-active lens. As shown, the mask 102 may have one or more openings 104 through which material may be deposited. In this example, the openings 104 of the mask 102 are shown as corresponding to electrical leads (e.g. conductive paths) that may be formed from the outer perimeter (or the periphery) of the substrate 101 to an electro-active element (not shown) disposed over a portion of the substrate 101. For example, a conductive layer 103 (e.g. comprising a transparent conductive oxide such as ITO or IZO) may be deposited through the openings 104 to form a conductive path to an electrode of an electro-active element such that electrical current or voltage may be applied to an electro-active element. In some examples, the conductive paths 103 may extend to the outer perimeter of the substrate 101, or may be disposed close to the perimeter (e.g. within 3.0 mm, but preferably within 1.0 mm) such that when the substrate 101 is edged and finished, the electrical leads may be exposed to form an electrical connection with an external conductor. It should be noted that although FIG. 1 shows an example of deposition of a conductive layer 103 that form electrical leads, embodiments are not so limited and the exemplary masks 102 disclosed herein may be utilized to deposit any suitable layer over the substrate 101.

When applying one or more layers of materials to an electro-active lens (such as a conductive layer (e.g. Indium Tin Oxide (ITO)), an alignment layer (such as ROLIC), or any other layer of material that may be in a liquid or gas form to a surface of a substrate (such as over the diffractive optic of a composite lens), there are four (4) generally known defects that typically occur in the process. First, a defect can occur based on a lifting of the mask during the deposition process. This may cause seepage (e.g. material of a layer being applied to portions of the substrate or lens where they were not intended, or traversing from a region in which they were already applied), which may result in a non-uniform application of the layer (e.g. one or more layers disposed over an optical feature such as a diffractive optic or one or more layer comprising an electrical lead to an electro-active element).

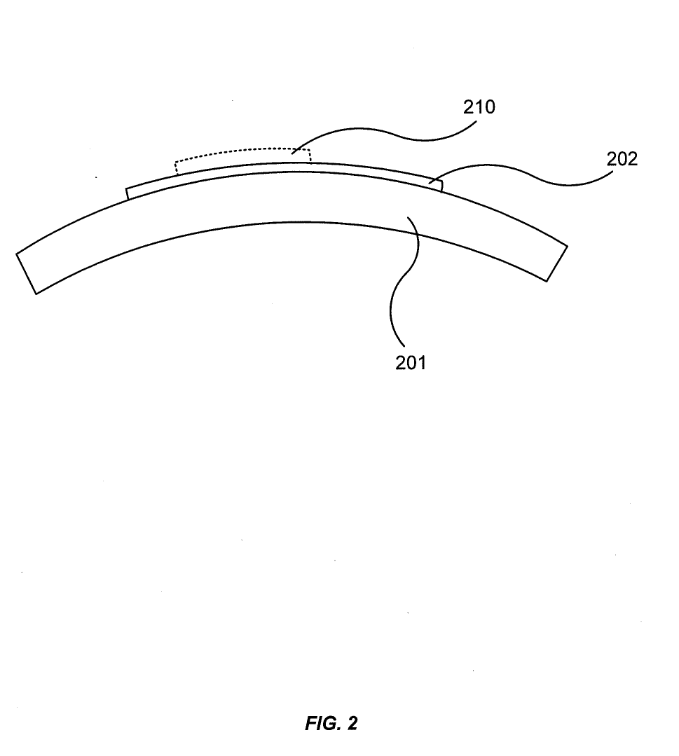

FIG. 2 shows an example of a mask 202 that is lifting during a deposition process. As shown, the mask 202 is disposed over a portion of a substrate 201. During the deposition process, a force may be applied to the mask 202 that results in at least a portion 210 of the mask 202 elevating (or lifting) above the surface of the substrate 201. This could be caused by, for example, centrifugal forces created during a spin-coating deposition process—although similar forces may be applied in other deposition processes. Previously, an adhesive layer was applied over a surface of the mask 202 so that the mask 202 would adhere to the surface of the substrate 201 so as to reduce or eliminate the occurrence of lift. However, as described below the use of adhesive may create additional problems and defects in the lens manufacturing process. Moreover, to reduce the occurrence of lift, adhesive would typically need to be applied over an entire surface of the mask 202, which may be difficult and therefore portions 210 of the mask 202 may not have been adequately coupled to the substrate 201.

Another defect that may occur, in some instances using traditional masks, is a chemical reaction between a mask adhesive (i.e. an adhesive that may be used to couple the mask to a surface of the substrate) and a layer the liquid or gas material (e.g. the conductive layer, such as ITO, or an alignment layer), which can leave a white residue stain/line on portions of the substrate (such as around a diffractive element or electrical lead on the applicable surface of the substrate(s)). This may lead to cosmetic problems with the substrate and/or could be substantial enough that the substrate cannot be used for its intended purpose. Thus, it may be beneficial to reduce or eliminate the use of adhesives to couple a mask to a substrate.

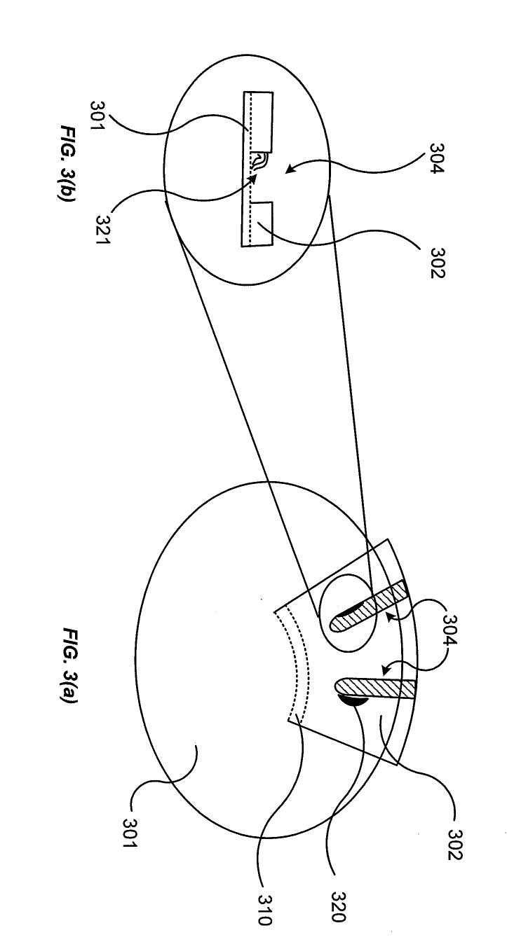

FIGS. 3(a) and (b) illustrate some of the above noted defects that may occur based, at least in part, on the use of adhesives and/or the lifting of conventional masks in fabricating electro-active lenses. FIG. 3(a) shows a mask 302 disposed over a substrate 301, where the mask 302 has openings 304 corresponding to the deposition of electrical leads (i.e. a conductive layer) extending from the outer perimeter of the substrate 301 to the interior of the substrate 301 that may comprise an electro-active element (not shown) such as an electrode or other component. The mask 302 is shown as having lift 310 over substrate 301 (that is, a portion 310 of the mask 302 is separating from the substrate 301 during a deposition process). This results in the example in FIG. 3(a) having leakage of material 320 that is deposited through the openings 304. That is, rather than the material 320 being disposed over the substrate 301 in the location of the openings 304 of the mask 302, because the mask is lifting above the surface of the substrate, the deposited material 320 is able to move to other locations of the substrate 301 (e.g. portions that were disposed under the mask 302). Moreover, as noted above, conventional masks often used adhesives over their surfaces to hold the mask in place during deposition, which may result in portions of the surface of the substrate 301 corresponding to regions of the mask 302 other than the openings 304 having an adhesive material present thereon. A chemical reaction may occur between the layer of material 320 and the adhesive disposed on the surface of the substrate 301 that may affect the performance of the conductive layer (or other layer of material being deposited on the substrate 301 through the mask 302) and/or may result in a residue (such as a milky-white residue) remaining after the deposition process.

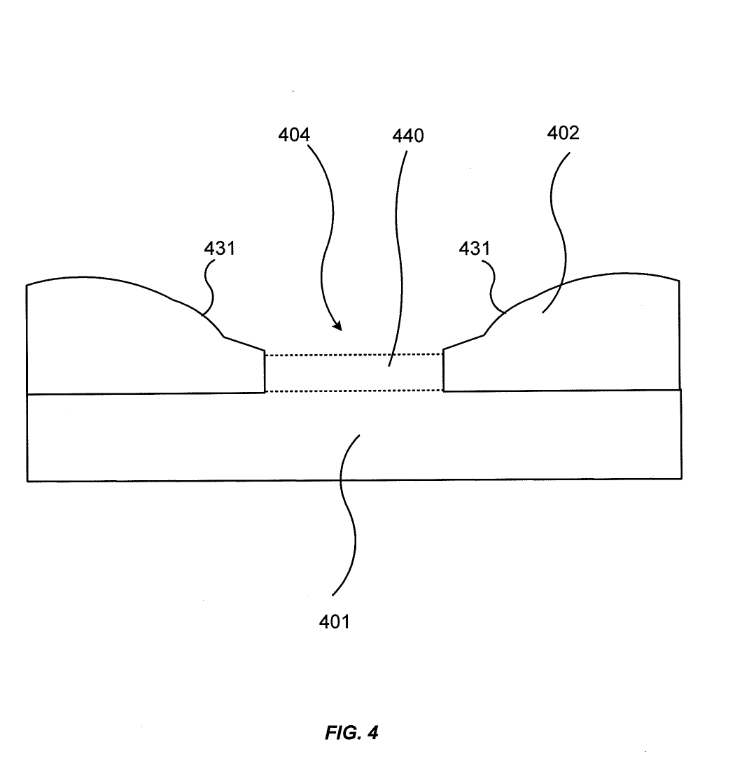

FIG. 3(b) is an enlarged view of a section of FIG. 3(a), and shows a cross-sectional view of the mask 302 disposed over the substrate 301. In particular, FIG. 3(b) shows the defect of the pooling of material 321 that is deposited though the opening 304 of the mask 302. As shown in this example, the opening 304 of mask 302 comprises substantially vertical walls (i.e. sides that are perpendicular to the surface of the substrate 301 on which material is being deposited), in contrast to some of the features that may be provided for with masks comprising materials provided herein (e.g. that may be die-cut) such as those shown in FIG. 4 and described in more detail below. The pooling of material 321 may result in non-uniform distribution of the material 321 over portions of the substrate 301, and could thereby affect performance of the device and/or create a noticeable visual defect on the substrate 301.

Another defect when using a typical mask to deposit layers on a substrate of an electro-active lens corresponds to the fact that these masks are not currently die cut type masks. Die cutting may refer to a process that cuts stock without the formation of chips or the use of burning or melting. Some embodiments provided herein may include a mask comprising a material that can be die cut so as to, for instance, add features to the edge of the mask to reduce the amount of liquid material pooling or build-up which interferes with the cosmetic compliance of the end product. Moreover, such masks may be readily be duplicated, which may provide the ability to manufacture more uniform lenses through the application of layers through different masks having the same features.

An example of an embodiment of a die-cut mask is shown in FIG. 4. In this regard, FIG. 4 shows a cross-sectional view of a die-cut mask 402 disposed over a substrate 401. As shown, the die-cut mask 402 has opening 404 through which a layer of material 440 may be deposited. The die-cut mask 402 is shown as having features 431 that comprise an inwardly sloping surface such that material 440 that is deposited over the mask 402 is directed into the opening 404, which may further reduce pooling or other imperfections that occur when depositing a layer. Moreover, because the mask 402 may comprise a material that is suitable for die-cutting, a plurality of such masks may be fabricated using a single layer of mask material (e.g. an electro-static plasticized material), where each mask may have substantially the same features 431.

In addition, the current masks utilize an adhesive that, even if it does not contaminate any of the other deposited layers as described above, typically leaves behind a residue that will ultimately need to be cleaned-off. This residue is a form of contamination and may require subsequent over-processing during manufacturing that can cause cosmetic damage to the surface of the substrate. This residue (and subsequent removal process) could also reduce the final bonding strength of the composite layers due to an inadequate surface preparation or residual mask adhesive contamination.

Some embodiments provided herein may comprise a mask, and methods of depositing one or more layers using the mask, that may reduce or eliminate some or all of the problems noted above. In some embodiments, the mask material may comprise a highly plasticized, flexible, adhesive-free PVC film laminated to a release liner (such as materials of 10# to 112#). In general, plastic static cling vinyl adheres tightly to most clean, smooth surfaces. It should be noted that the availability of vinyl masking materials is not limited to any specific configuration. That is, for example, the correct material thickness and exact composition can range from, but is not limited to 6.0 mils-12.0 mils. However, the exact dimensions and configuration will typically depend on the actual process application. The range of different vinyl static cling compositions in some embodiments may support solvent, aqueous, flexible, non-coated vinyl or non-ortho phthalate plasticizer for a variety of liquid material applications. However, embodiments are not so limited.

The inventors have found that by using an electro-static mask comprising (e.g. made out of), for instance, 10.0 mils of 90# stay flat liner material (or similar material), may reduce or eliminate the need for an adhesive material to be used to couple the mask to the surface (or otherwise dispose the mask over the surface) of the substrate during deposition. This may thereby reduce or eliminate some of the chemical interactions described above that may be caused by the use of such an adhesive material, which as noted above can cause aesthetic imperfections or defects to form on the substrate (or could require additional processing steps to remove the adhesive material). For example, the exemplary electro-static mask comprising (e.g. made out of) 10MIL 90# stay flat liner material was also found to have sufficient strength and durability to resist the g-forces typically incurred during spin coating processes for depositing the alignment layer and conductive layer (e.g. ITO)—that is, the inventors found that a mask comprising 10MIL 90# stay flat liner material had sufficient electro-static interaction with the surface of the substrate such that it remained substantially in place even when experiencing the g-forces associated with the deposition process. Such forces are typically experienced as part of the manufacturing process (although other deposition process may also be used, which may result in different forces being applied to the mask while it is disposed over the substrate). Thus, the inventors found that through the use of such materials for the deposition mask, embodiments may eliminate or reduce the need for an adhesive layer disposed between the substrate and the mask. Moreover, the exemplary masks were found to have sufficient force such that it could also provide a proper edge treatment and avoid edge lift due to g-force or lift due to chemical interaction, as illustrated in FIGS. 2 and 3(a) above.

Additionally, the inventors found that this type of masking process may provide similar benefits as it relates to other process areas requiring a mask in the production of a composite lens blank when using, for example, pliable liquids. That is, the use of an electro-static mask may generally be used during any suitable deposition process of disposing material over a surface of the substrate, and may offer similar benefits in the reduction or elimination of the use of an adhesive material during such process, as well as providing sufficient coupling of the mask to the substrate to avoid lift.

In some embodiments, an electro-static mask may be provided. The electro-static mask may be made out of 10MIL 90# Stay flat liner or similar material which, when used during the application of conductive layer (e.g. an ITO layer), alignment layer (such as the commercially available Rolic® Light Controlled Molecular Orientation (LCMO)) or similar liquids typically required for assembling a composite lens blank, may provide a secure and adequate mask while eliminating or reducing the chemical interactions that may typically result from the use of an adhesive layer or material.

In some embodiments, an electro-static mask may be provided that is made out of 10MIL 90# Stay flat liner or similar material which, when used during the application of a conductive layer (e.g. ITO), alignment layer (e.g. ROLIC® LCMO) or similar liquids typically required for assembling a composite lens blank, the mask may provide a secure and adequate mask while preventing a lift of the mask during a spin coating process or due to chemical interaction(s).

In some embodiments, an electro-static mask may be provided that may comprise 10MIL 90# Stay flat liner or similar material which, when used during the application of a conductive layer (e.g. ITO), an alignment layer (e.g. ROLIC ® LCMO) or similar liquids typically required for assembling a composite lens blank, may provide a secure and adequate mask while preventing or reducing pooling or build-up of liquid material against the mask by altering the edge feature of the mask through die cutting.

An electro-static mask made out of 10MIL 90# Stay flat liner or similar material which, when used during the application of an ITO, ROLIC or similar liquids required for assembling a composite lens blank provides a secure and adequate mask while eliminating the need for adhesive material subsequently eliminating the contamination and the need for an overly aggressive cleaning process.

### Exemplary Embodiments

Described below are exemplary embodiments of methods of manufacturing, such as for manufacturing an electro-active lens, that may include the use of an electro-static mask. The embodiments described herein are for illustration purposes only and are not thereby intended to be limiting. After reading this disclosure, it may be apparent to a person of ordinary skill in the art that various components and/or features as described below may be combined or omitted in certain embodiments, while still practicing the principles described herein.

Embodiments provided herein may comprise electro-active lenses, and methods of manufacturing an electro-active lens, that may comprise the use of an electro-static mask. The mask may, for instance, be utilized to deposit one or more patterned layers of materials over a surface of a substrate of the electro-active lens, such as one or more conductive layers, alignment layers, or any other patterned layer. The mask may comprise properties such that it may be coupled to a surface of the substrate based, at least in part, on electro-static forces. In some embodiments, this may reduce or eliminate the use of adhesive materials and layers (which could contaminate or otherwise affect the one or more layers of the device) that may otherwise be used to hold the mask in place.

In some embodiments, a method for manufacturing an electro-active lens may be provided. The method may comprise the steps of providing a substrate having a first surface; disposing a mask over at least a portion of the first surface of the substrate, where the mask comprises an electro-static plastic material and where the mask has at least one opening; and depositing a layer of material through the at least one opening of the mask.

As used in this context, “electrostatic plastic materials” may refer to films that may comprise plastic materials that may adhere to the surface of a substrate (such as smooth glass, metal, and/or plastic substrates) based on an electro-static force. Such materials may generally belong to the category of vinyl films, such as PVC (polyvinyl chloride) films, or may belong to the category of polyolefine films, such as polyethylene (PE), polypropylene (PP), etc. Some examples of commercially-available brands of electrostatic PVC films are: Grafix® Cling PVC Film and Achille® flexible PVC film. However, embodiments are not limited to PVC films, and other materials such as PE-based or PP-based films may also be utilized in some embodiments.

The step of depositing material through the at least one opening may comprise any suitable method for depositing material, including by way of example only, spin-coating, spray-coating, dip-coating, or any other suitable process.

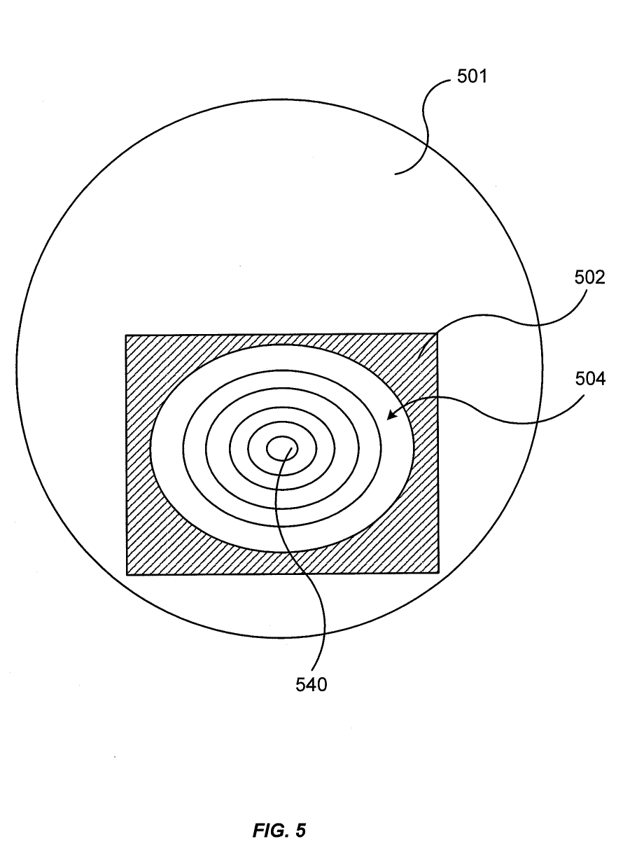

The mask may have one, or more than one opening through which material may be deposited. For example, FIGS. 2 and 3(a) illustrate embodiments of a mask comprising two openings corresponding to the deposition of conductive leads from the outer perimeter of the substrate to one or more components that may be disposed on the surface of the lens. However, embodiments are not so limited. For instance, FIG. 5 shows an exemplary embodiment of a mask 502 disposed over the surface of a substrate 501, where the surface of the substrate comprises an optical feature 540. The mask 502 is shown as being aligned over the substrate 501, such that the opening 504 is aligned (e.g. disposed over) the optical feature 540. In this manner, one or more layers of material (such as a conductive layer, alignment layer, etc.) may be disposed over the optical feature 540 (or portions thereof), but may not be disposed over other portions of the surface of the substrate 501.

In the example shown in FIG. 5, the optical feature 540 is shown as comprising a diffractive optical feature disposed on the surface of the substrate 501. For example, the exemplary electro-active lens may comprise an electro-active element that comprises one or more layers disposed over the optical feature 540. The layers could include, by way of example only, a conductive layer (e.g. a first electrode) disposed over a diffractive optic 540; an insulating layer (e.g. SiO₂) disposed over the conductive layer; a liquid crystal alignment layer disposed over the insulating layer; a liquid crystal material disposed over the alignment layer; a second liquid crystal alignment layer disposed over the liquid crystal material; a second insulating layer disposed over the second alignment layer; and a second conductive layer (e.g. second electrode) disposed over the second insulating layer. A second substrate may then be disposed over the second conductive layer. It should be appreciated that embodiments may include additional layers other than those noted above, or may not include one or more of the example layers. Moreover, each of the layers may be deposited by any suitable process, and each layer may (or may not) be deposited through a mask).

Although the optical feature 540 shown in the example in FIG. 5 was described above as comprising a diffractive optic, embodiments are not so limited. For example, the optical feature 540 may comprise a pixilated optical feature (such as a pixilated electrode) and the mask 502 may comprise a plurality of openings 504 corresponding to each of the separate pixilated portions of the electrode. In this way, a conductive layer may be deposited though the openings 504 of the mask 502 to form the pixilated electrodes of the electro-active lens. However, as noted above, the electro-active lens may comprise any suitable layers and features. For example, the optical feature 540 of the substrate 501 could comprise a progressive addition surface, and the mask may be configured and aligned so as to deposit one or more layer of material over all or a portion of the progressive addition surface (e.g. so that the electro-active element is in optical communication with the optical feature 540 or a portion thereof). In some embodiments, the mask 502 may be aligned so as to deposit material layers over portions of the substrate 501 that do not comprise the optical feature 540 (that is, the mask 502 may be aligned over the substrate 501 such that the one or more openings 504 of the mask 502 are not disposed over the optical feature 540). For example, the openings 504 of the mask 502 may be disposed over portions of the substrate 501 that correspond to regions of the electro-active lens that experience distortion (such as an astigmatism) from the optical feature 540.

In some embodiments, in the method as described above, the electro-static plastic material may comprise a vinyl film. As noted above, the inventors have found that the use of vinyl films may have properties such that a sufficient electro-static force may result from disposing the mask comprising such material over typical substrates used for electro-active lenses (such as smooth glass, plastic, or resin material), thereby allowing for deposition through the mask without the need for an adhesive material. In some embodiments, the vinyl film may comprise PVC.

In some embodiments, in the method as described above, the mask may have a thickness that is between 50 and 200 microns. In general, the masking films should be made to be as thin as possible, but it is desirable that the mask is thick enough to be readily handled during manufacturing. The inventors have found that in some embodiments, an acceptable range of thickness may be between 50 and 200 microns; however, embodiments are not so limited. For example, in some embodiments, the mask may have a thickness that is less than 200 microns. In some embodiments, the mask may have a thickness that is greater than 50 microns.

In some embodiments, in the first method as described above, the mask may adhere to the first surface of the substrate based on an electro-static interaction. The electro-static interaction may create “static cling,” which may refer to when the electro-static force between the substrate and the mask is sufficient to hold the mask over a portion of the substrate (particularly when a force is applied, such as a centrifugal force created during a deposition process). It should be noted that the electro-static force that may be required for use of a mask for depositing materials on a substrate is generally dependent on the manufacturing conditions of the device. For example, the determination of the force needed may be dependent on factors such as the spin-speed during deposition and/or the diameter of the substrate, each of which may affect the centrifugal force experienced by the mask. Similarly, the amount of force required for the mask to function properly (e.g. be held in place over a desired portion of the substrate) may depend on the deposition process used—e.g. a spin coating deposition process may create more force on the mask than a dip coating or spray coating process. In addition, the amount of electro-static force created between the mask and the substrate may depend on the properties of the substrate as well as the mask (such as the material of the substrate, the surface topography of the substrate, etc.). It is generally considered, after reading this disclosure, to be within the knowledge of a person of ordinary skill in the art to select approiate material properties for the mask and substrate based on the determination of force required to maintain the mask coupled to the substrate during a deposition process.

In some embodiments, the electro-static interaction may create an electro-static force between the first surface of the substrate and the mask of at least 200N. In some embodiments, the electro-static interaction may create an electro-static force between the first surface of the substrate and the mask of at least 600N. In some embodiments, the electro-static interaction may create an electro-static force between the first surface of the substrate and the mask of between 200 and 600N. In the inventor's lab, typical values for the forces experienced by a mask coupled to a substrate having weight between 40-80 g (e.g. cribbed BC 4.25 diffractive is ca.43 grams), a diameter of between 7-8 cm, and when spinning at 3,000 rpm; the centrifugal force (F_{c}) is in the range of 200-600 N, where F_{c}=mV²/R or F_{c}=mw²R (F_{c}=centrifugal force; m=mass; R=radius; V=linear velocity; w=angular velocity). Thus, for a preferred embodiment, the electrostatic masking film may be designed to “survive” the centrifugal forces of at least 600 N.

In some embodiments, the electro-static interaction may create a peel strength of at least 0.1 N per 25 mm width. As used in the context, “peel strength” may refer to the load/force per unit width of bond line required to separate the film/tape (in this case the mask) from the surface. The inventors have found that for typical substrates (e.g. substrates comprising a diffractive surface), a masking film having a peel strength of at least 0.1 N/25 mm was generally adequate to maintain a sufficient coupling of the components during the deposition process.

In some embodiments, in the method as described above, the mask may be flexible. That is, the mask may comprise a flexible material that may create additional degrees of freedom and also allow the mask to more readily conform to the surface of the substrate.

In some embodiments, the mask may comprise a material having a flexural rigidity between 30 and 60 MPa. As used in this context, the “flexural rigidity” may be defined as the force couple required to bend a rigid structure to a unit curvature. For a uniform film or material (e.g. mask), flexural rigidity can be described mathematically as:

(1)D=Et³/12(1−μ²)

Where D is flexural rigidity (in Nm), E is Young's modulus (in Nm²), μ is Poisson's ratio and t is the thickness of the substrate (in m).

In some embodiments, the method as described above may further include the steps of disposing a liner between the mask and the substrate. In some embodiments, the liner that is disposed between the mask and the substrate may comprise any one of, or some combination of polyolefins (e.g. PP, HDPE, LDPE), PVC, PET, paper or any other suitable material. In some embodiments, the liner material may serve as an intermediate layer between the mask and the substrate. In some instance, the liners (or release liners) can be made of variety of materials that may further include a release agent on one or both sides (release agents can be, for example, a silicone-based, Teflon-based material or any other material with low surface energy). In some instances, the liner can be used instead of, or in addition to, the use of a mask.

In some embodiments, in the method as described above, the step of depositing the layer of material through the at least one opening of the mask may comprise spin coating, spray, dip-coating, or any other suitable process. As noted above, embodiments are not so limited and may comprise any suitable deposition process.

In some embodiments, in the method as described above, the step of disposing the mask over at least a portion of the first surface of the substrate may comprise aligning the mask based at least in part on an optical feature disposed on the first surface of the substrate. An example of such an embodiment was described above with reference to FIG. 5. In some embodiments, the step of aligning the mask based at least in part on an optical feature disposed on the first surface of the substrate comprises aligning the mask such that at least one opening of the mask is disposed over the optical feature. For example, the optical feature may comprise a diffractive structure disposed on the surface of the substrate, and the mask be aligned so as to deposit a liquid crystal electro-active element over the optical feature. However, embodiments are not so limited, and the mask may be aligned such that the openings are not disposed over the optical feature (such as to deposit on or more conductive leads (such as those shown in FIGS. 1 and 3(a), from the outer perimeter of the substrate to the optical feature and any layers disposed thereon). In some embodiments, the optical feature may comprise a diffractive element, a progressive addition surface, or a pixilated element.

In some embodiments, in the method as described above, an adhesive layer may not be disposed between the substrate and the mask. In some instances, an adhesive layer may not be disposed so as to be directly adjacent to the surface of the substrate. As noted above, embodiments may provide the advantage of utilizing a mask that may reduce or eliminate the need to use an adhesive to couple the mask to the surface of the substrate. This may reduce the occurrences of contamination of the electro-active element layers, reduce the number of processing steps (such as, for instance, eliminating the need to remove the remnants of the adhesive from the surface of the substrate), and/or reduce the occurrences of noticeable defects that may result form the use of an adhesive.

In some embodiments, in the method as described above, the layer of material deposited through the at least one opening of the mask may comprise any one of, or some combination of: a conductive layer or a liquid crystal alignment layer. In some embodiments, where the layer of material deposited through the at least one opening of the mask comprises a conductive layer, the layer may comprise a transparent conductive oxide (TCO) such as ITO or IZO. In some embodiments, where the layer of material deposited through the at least one opening of the mask comprises a liquid crystal alignment layer, the layer may comprise an olyimide, polyvinyl alcohol, polyacrylate, polymethacrylate, polyurethane or epoxy material. In some embodiments, the layer of material deposited through the at least one opening of the mask may comprise a liquid crystal material such as nematic, smectic, or cholesteric liquid crystals. In some embodiments, the layer of material deposited through the at least one opening of the mask may comprise an electro-chromic material.

In some embodiments, the method as described above may further comprise the step of providing the mask, wherein providing the make comprises die-cutting. As noted above, “die cutting” may refer to a process which cuts stock without the formation of chips or the use of burning or melting. The mask may also thereby comprise a material that may allow features to be cut or otherwise formed into the mask, thereby allowing for improved deposition, an example of which is shown in FIG. 4 and described above.

In some embodiments, a method may be provided. The method may comprise providing a substrate having a first surface; disposing a mask over at least a portion of the first surface of the substrate, wherein the mask comprises an electro-static material that creates an electro-static force between the first surface of the substrate and the mask of at least 200N and where the mask has at least one opening; and depositing a layer of material through the at least one opening of the mask.

In some embodiments, in the method as described, the substrate may comprise an outer perimeter and the step of disposing the mask over at least a portion of the first surface of the substrate may comprise positioning at least the one opening over a region of the first surface that extends to within 3.0 mm of the outer perimeter. In some embodiments, the step of disposing the mask over at least a portion of the first surface of the substrate comprises positioning at least the one opening over a region of the first surface that extends to within 1.0 mm of the outer perimeter. In some embodiments, the step of disposing the mask over at least a portion of the first surface of the substrate may comprise positioning at least the one opening over a region of the first surface that extends to the outer perimeter. In some embodiments, the layer of material deposited through the at least one opening of the mask may comprise a conductive material. In some embodiments, the method may further include the step of edging the substrate so as to expose the conductive layer.

In some embodiments, in the method as described, the substrate may comprise an outer perimeter and the first surface of the substrate may comprise an optical feature. In some embodiments, the step of disposing the mask over at least a portion of the first surface of the substrate may comprise positioning at least the one opening over a region of the first surface that extends from the optical feature to the outer perimeter. In some embodiments, the step of disposing a mask over at least a portion of the first surface of the substrate may comprise positioning an opening of the mask over the optical feature.

### CONCLUSION

It is understood that the various embodiments described herein are by way of example only, and are not intended to limit the scope of the invention. For example, many of the materials and structures described herein may be substituted with other materials and structures without deviating from the spirit of the invention. The present invention as claimed may therefore include variations from the particular examples and preferred embodiments described herein, as will be apparent to one of skill in the art. It is understood that various theories as to why the invention works are not intended to be limiting.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

Although many embodiments were described above as comprising different features and/or combination of features, a person of ordinary skill in the art after reading this disclosure may understand that in some instances, one or more of these components could be combined with any of the components or features described above. That is, one or more features from any embodiment can be combined with one or more features of any other embodiment without departing from the scope of the invention.

As noted previously, all measurements, dimensions, and materials provided herein within the specification or within the figures are by way of example only.

A recitation of “a,” “an,” or “the” is intended to mean “one or more” unless specifically indicated to the contrary.

As used herein, reference to a “first” or a “second” does not limit the referenced component to a particular location unless expressly stated. For instance, reference to a “first temple” may comprise the temple located on either the left side or the right side of a wearer's head.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

1. A method for manufacturing an electro-active lens, comprising the steps of:
providing a substrate having a first surface;
disposing a mask over at least a portion of the first surface of the substrate,
wherein the mask comprises an electro-static plastic material, and
wherein the mask has at least one opening;
depositing a layer of material through the at least one opening of the mask.

2. The method of claim I, wherein the electro-static plastic material comprises a vinyl film.

3. The method of claim 2, wherein the vinyl film comprises PVC.

4. The method of claim 1, wherein the mask has a thickness that is between 50 and 200 microns.

5-6. (canceled)

7. The method of claim 1, wherein the mask adheres to the first surface of the substrate based on an electro-static interaction.

8-9. (canceled)

10. The method of claim 7, wherein the electro-static interaction creates an electro-static force between the first surface of the substrate and the mask of between 200 and 600N.

11. The method of claim 7, wherein the electro-static interaction creates a peel strength of at least 0.1 N per 25 mm width.

12. The method of claim 1, wherein the mask is flexible.

13. The method of claim 1, wherein the mask comprises a material having a flexural rigidity between 30 and 60 MPa.

14. The method of claim 1, further comprising the steps of disposing a liner between the mask and the substrate.

15. The method of claim 14, wherein the liner between the mask and the substrate comprises any one of or some combination of polyolefins (PP, HDPE, LOPE), PVC, PET, paper.

16. The method of claim 1, wherein the step of depositing the layer of material through the at least one opening of the mask comprises at least one of: spin coating, spray-coating, or dip-coating.

17. The method of claim 1, wherein the step of disposing the mask over at least a portion of the fust surface of the substrate comprises aligning the mask based a t least M put on an optical feature disposed on the first surface of the substrate.

18. (canceled)

19. The method of claim 17, wherein the optical feature comprises a diffractive element

20. (canceled)

21. The method of claim 1, wherein the layer of material deposited through the at least one opening of the mask comprises any one of, or some combination of: a conductive layer or a liquid crystal alignment layer.

22. The method of claim 1, wherein the layer of material deposited through the at least one opening of the mask comprises a transparent conductive oxide (TCO).

23. (canceled)

24. A method comprising
providing a substrate having a first surface and a first optical feature;
disposing a mask over at least a portion o the first surface of the substrate,
wherein the mask comprises an electro-static material that creates an electro-static force between the first surface of the substrate and the mask of at least 200N; and
wherein the mask has at least one opening;
depositing a layer of material through the at least one opening of the mask

25. The method of claim 24,
wherein the substrate comprises an outer perimeter; and
wherein disposing the mask over at least a portion of the first surface of the substrate comprises positioning at least the one opening over a region of the first surface that extends to within 3.0 mm of the outer perimeter.

26-27. (canceled)

28. The method of claim 25, wherein the layer of material deposited through the at least one opening of the mask comprises a conductive material.

29. The method of claim 25, further comprising the step of edging the substrate so as to expose the conductive layer.

30. The method of claim 24,
wherein the substrate comprises an outer perimeter;
wherein the first surface of the substrate comprises an optical feature; and
Wherein disposing the mask over at least a portion of the first surface of the substrate comprises positioning at least the one opening, over a region of the first surface that extends from the optical feature to the outer perimeter.

31. (canceled)
